(19) United States
(12) Patent Application Publication
(10) Pub. No.: US 2015/0362148 A1
(43) Pub. Date: Dec. 17, 2015

(54) Personal Video Conference Lighting Assembly

(71) Applicant: BRIGHTLINE, INC., Bridgeville, PA (US)

(72) Inventor: Katherine Jo Katz, McMurray, PA (US)

(21) Appl. No.: 14/735,264

(22) Filed: Jun. 10, 2015

Related U.S. Application Data
(60) Provisional application No. 62/010,723, filed on Jun. 11, 2014.

(51) Int. Cl. F21V 5/04; F21V 23/02; F21V 23/00; F21V 7/00

(52) U.S. Cl. CPC F21V 5/04; F21V 7/0091; F21V 23/02; F21V 23/005; F21Y 2101/02

(57) ABSTRACT

A lighting assembly for use in connection with personal video conferencing includes a plurality of LEDs and can be mounted easily to a personal computing device. The lighting assembly can include a tiltable base that supports the personal computing device at various angles. The LEDs can be configured to emit converging, overlapping light that provides a continuous field of light on the user, and minimizes hot spots, bands of light, and user discomfort.

The present application claims priority to U.S. Provisional Patent Application No. 62/010,723, entitled Personal Video Conference Lighting Assembly, filed on Jun. 11, 2014, the disclosure of which hereby is incorporated by reference as if fully restated herein.

This application incorporates by reference the disclosure of U.S. Design Patent Application No. 29/493597, entitled Personal Video Conference Lighting Assembly, filed on Jun. 11, 2014, as if fully restated herein.

### BACKGROUND OF THE INVENTION

1. Field of the Invention

The invention relates in general to a lighting assembly and, more particularly, to a lighting assembly to be used for, among other things, personal video conferencing and video streaming applications—such as, but not limited to, Internet video streaming applications.

2. Description of Related Art

As personal computing devices—such as desk top computers, lap top computers, notebook computers, tablet computers, smart phones, as well as others—become smaller, less costly, and more powerful, their use proliferates. Many of personal computing devices are usable with external video cameras, or themselves include integrated video cameras.

Additionally, as global information networks—such as the Internet—proliferate, individuals, government organizations, and businesses increasingly are using personal computing devices for video conferencing. Video conferencing quickly is becoming a common mode of communication, as it allows participants in remote locations to meet and converse with one another as if they were present in the same room. Such video conferences may involve conversations between individuals, or conferences between groups, and may include, without limit, topics such as personal activities, commerce, academics, or telemedicine.

In any setting, proper lighting makes a tremendous difference in how people appear, and thus how they communicate, during a video conference or distance education session. Typical indoor ambient lighting—such as in an office or home setting—can be inadequate for video conferencing. Improper lighting can create harsh shadows during video conferencing, or otherwise hide or obscure the nuances of facial expression, eye-contact, or other critical aspects of non-verbal communication. Thus, proper lighting, which helps to convey these features, is important for effective communication. This is especially important, as the Internet allows speakers of different languages to interact with each other via videoconferencing applications.

Additionally, as personal computing devices become smaller and more portable, the need exists for a small, portable lighting assembly. Such an assembly allows users to engage in video conferencing easily, with effective lighting, anywhere an Internet connection is available. Moreover, given the typical proximity of the user's eyes to the video camera of a personal computing device during personal video conferencing, it is desirable that a lighting assembly would be configured to minimize eye strain or user discomfort.

### SUMMARY OF THE INVENTION

Generally provided herein is a personal video conference lighting assembly that is lightweight, portable, and provides sufficient illumination to portray nuances of facial expression, eye-contact, or other critical aspects of non-verbal communication. The personal video conference lighting assembly provides lighting sufficient for a variety of personal video conferencing applications, such as personal communications, business, distance learning, and telemedicine. In a non-limiting embodiment, the personal video conference lighting assembly engages easily with a personal computing device and is easily operated by a user. Desirably, the personal video conference lighting assembly also provides high-quality illumination that minimizes eye strain and user discomfort.

Disclosed herein is a lighting assembly for use with personal computing devices. According to an embodiment, the lighting assembly includes a housing forming an interior cavity, in which a light emitting diode (LED) circuit board may be situated. At least one LED may be positioned to emit light through a front portion of the housing to illuminate the face of a user during video conferencing. Desirably, the LEDs may be configured to provide converging light that is continuous—minimizing hot spots and bands of illumination. In an embodiment, this may be accomplished through the use of optics, such as beam shaper optics. Thus, user eye strain and discomfort may be minimized. Additionally, the intensity of the light and a user's ability to control the orientation of the LED housing in certain embodiments may further contribute to user comfort during use of the lighting assembly.

In an embodiment, the housing may be connected to a neck that enables an orientation of the housing to be adjusted by the user. The neck may connect to a base unit. The base unit may have at least one support mechanism that allows the base unit to be positioned at a variety of angles. In a non-limiting embodiment, the support mechanism may include at least one rotatably-retractable leg unit. The base unit also may have a mechanism on its front portion to aid in the support of a personal computing device thereon.

In another embodiment, the neck connects the LED housing to a clipping mechanism that engages a personal computing device without a base unit. In accordance with another embodiment, the housing connects to the clipping mechanism without the use of a neck. These embodiments may allow the user to adjust the orientation of the housing without moving the personal computing device, or the housing may remain fixed with respect to the personal computing device.

Various non-limiting embodiments of the present invention enable varying degrees of ease of mobility, allowing a user to move about freely and untethered during video conferencing, while maintaining adequate and consistent light levels for enhanced camera imaging. Thus, a user may use the lighting assembly to illuminate his or her facial features during video conferencing in a manner that provides high-quality imaging, while minimizing discomfort.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. As used in the specification and the claims, the singular form of “a”, “an” and “the” include plural referents unless the context clearly dictates otherwise.

### BRIEF DESCRIPTION OF THE DRAWINGS

FIG. 1 is an exploded perspective view of an embodiment of a personal video conference lighting assembly including a base unit;

FIG. 2A is a rear view of the personal video conference lighting assembly of FIG. 1;

FIG. 2B is a side view of the personal video conference lighting assembly of FIG. 1;

FIG. 3 is an exploded perspective view of an arm clip member that may be included in the personal video conference lighting assembly of FIG. 1;

FIG. 4 is a front view of an LED board of the personal video conference lighting assembly;

FIG. 5A is a side view of the personal video conference lighting assembly showing a leg member in a deployed position;

FIG. 5B is a side view of the personal video conference lighting assembly according to FIG. 5A showing a leg member and leg support member in a deployed position;

FIG. 5C is a side view of the personal video conference lighting assembly according to FIG. 5A showing a leg member and leg support member in another deployed position;

FIG. 5D is a front view of the personal video conference lighting assembly of FIG. 5A;

FIG. 6A is a front view of an embodiment of a personal video conference lighting assembly including a clipping mechanism;

FIG. 6B is a side view of the personal video conference lighting assembly according to FIG. 6A;

FIG. 7A is a front view of an embodiment of a personal video conferencing assembly including a clipping mechanism;

FIG. 7B is a side view of the personal video conferencing assembly according to FIG. 7A;

FIG. 8 is a front view of an embodiment of an LED housing and flexible neck;

FIG. 9A is a front view of an embodiment of a personal video conferencing assembly including a clipping mechanism, neck, and power supply housing;

FIG. 9B is a rear view of the personal video conferencing assembly including a clipping mechanism, neck, and power supply housing;

FIG. 10A is a front view of an embodiment of an LED housing;

FIG. 10B cross-sectional side view of the LED housing taken along line A-A in FIG. 10A;

FIG. 11A is a top view of an embodiment of optics according to the present invention;

FIG. 11B is a side view of optics according to FIG. 11A;

FIG. 11C is a bottom view of the of the optics according to FIG. 11A

FIG. 12A is a front perspective view of an embodiment of personal video conferencing assembly;

FIG. 12B is a rear perspective view of the personal video conferencing assembly according to FIG. 12A;

FIG. 13A is a front view of an embodiment of an LED housing, depicting the emission of light, wherein optics are not included;

FIG. 13B is a front view of an embodiment of an LED housing, depicting the emission of light, wherein optics are included

FIG. 14 is a bottom view of an embodiment of an LED housing.

### DETAILED DESCRIPTION OF THE INVENTION

For purposes of the description hereinafter, the spatial orientation terms and derivatives thereof shall relate to the embodiment as it is oriented in the drawing figures. However, it is to be understood that the invention may assume various alternative variations, except where expressly specified to the contrary. It is also to be understood that the specific devices illustrated in the attached drawings, and described in the following specification, are simply exemplary embodiments. Hence, specific dimensions and other physical characteristics related to the embodiments disclosed herein are not to be considered as limiting.

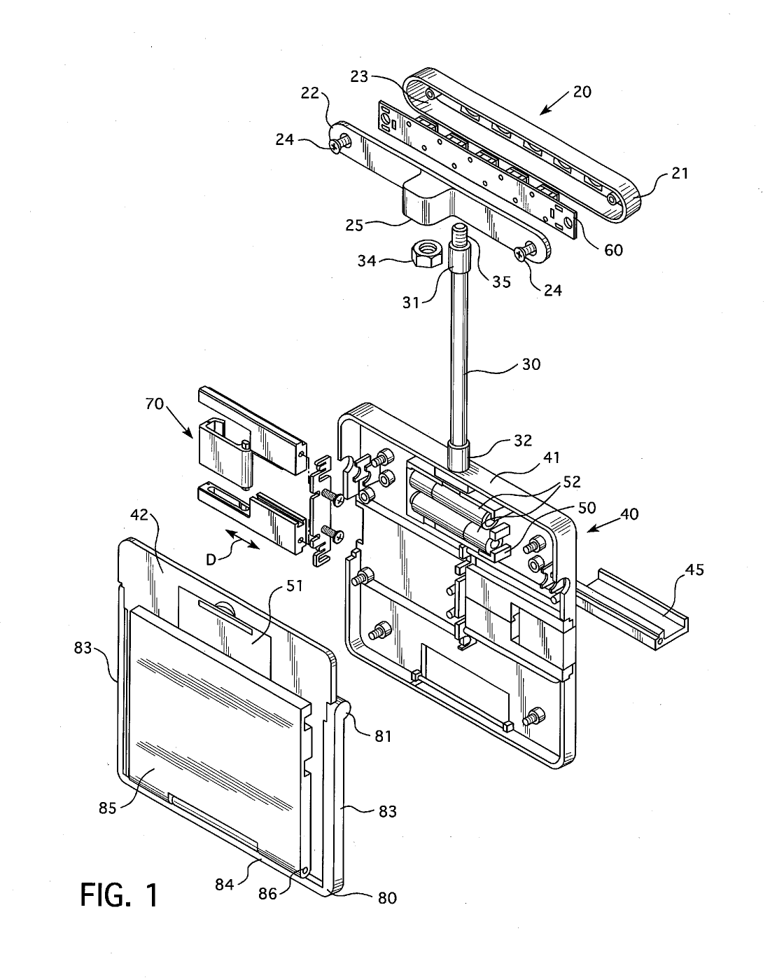

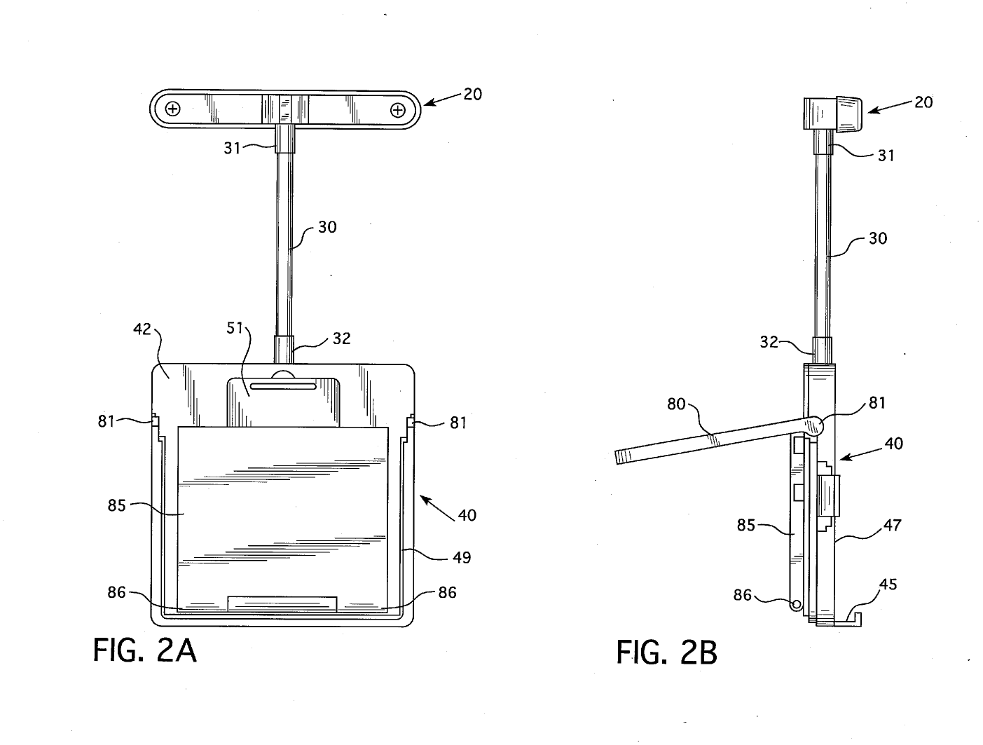

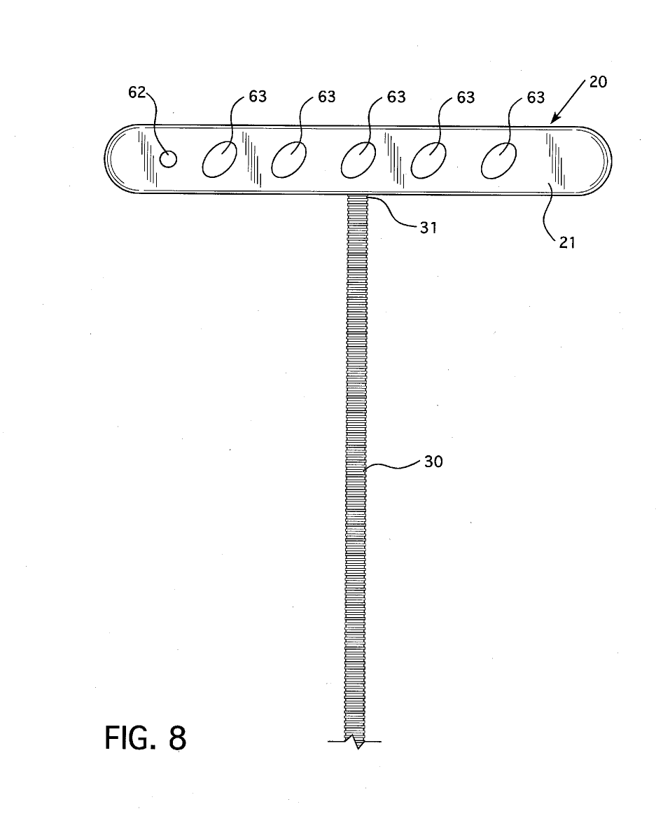

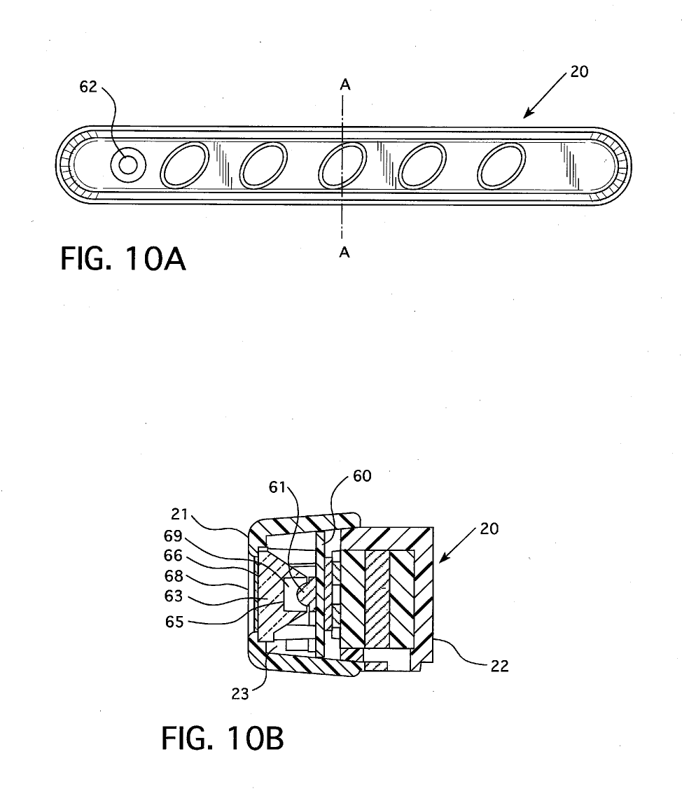

With reference to FIGS. 1 and 2A-2B, an embodiment of lighting assembly 10 is shown that includes a base unit 40 on which a personal computing device may be placed. FIG. 2A shows a rear view of an embodiment shown in FIG. 1. This non-limiting embodiment of lighting assembly 10 includes an LED housing 20 having a generally horizontally-elongated shape. LED housing 20 includes a front portion 21 and a back portion 22, which may be fastened together with mechanical fasteners 24, or other methods of fastening, such as adhesive or complimentary interlocking parts. An embodiment of LED housing 20 is shown in FIGS. 8 and 10A-10B as well.

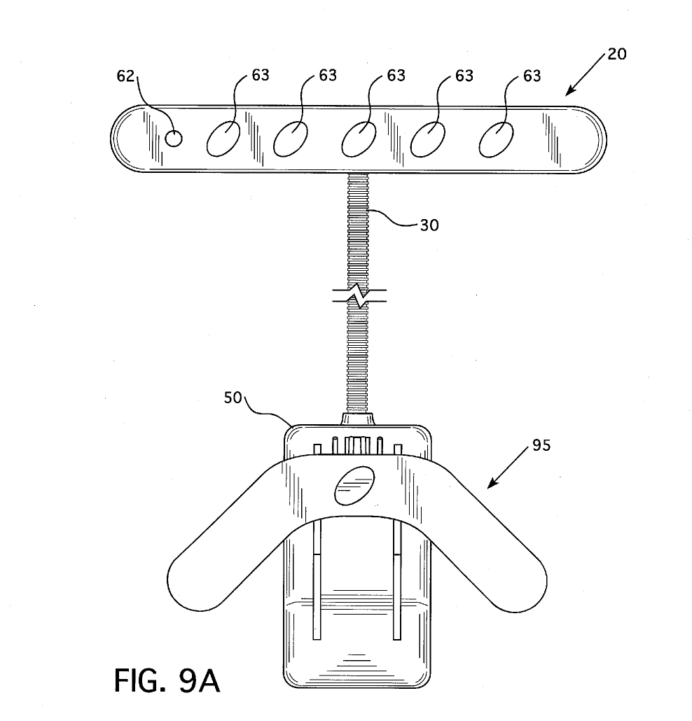

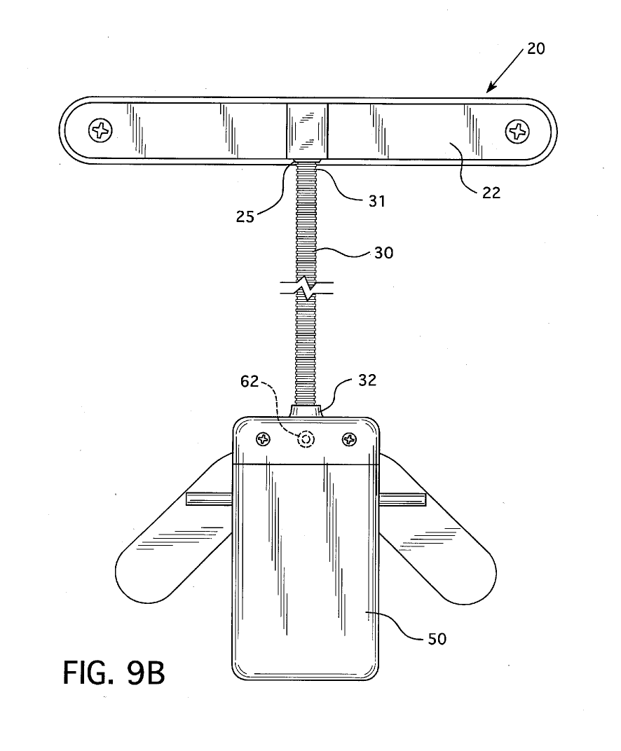

With reference to FIGS. 9B and 14, back portion 22 of LED housing 20 may include a port 25 disposed at a substantially central portion thereof, and may be affixed to a first end 31 of neck 30. Embodiments of neck 30 may be rigid or flexible. Embodiments of neck 30 may allow a user to adjust the orientation of LED housing 20 in order to optimize illumination of a user's face and/or other object during video conferencing. Adjustment of the angle and/or orientation of LED housing 20 also may contribute to user comfort.

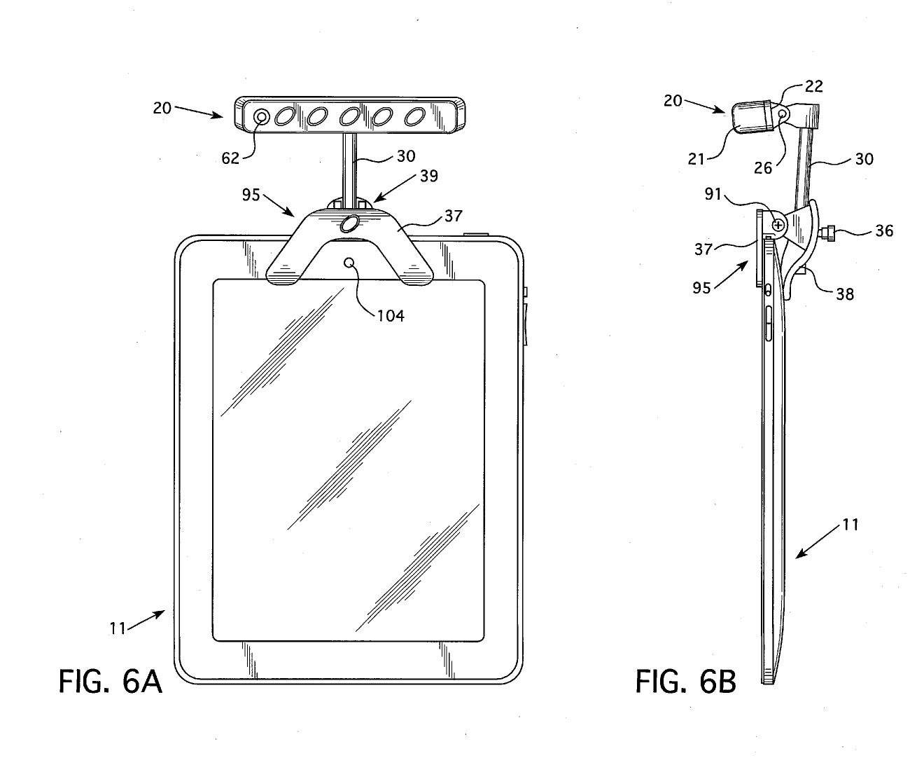

With reference to FIGS. 6A and 6B, an embodiment of neck 30 may be rigid, and may be comprised of plastic, aluminum, or some other equivalent material, whereupon angle and/or orientation of LED housing 20 may be effected by pivots 26 or swivels attached to LED housing 20 and/or neck 30. In an embodiment depicted in FIGS. 2A and 2B, a second end 32 of neck 30 may be attached to a top portion 41 of the base unit 40. Neck 30, LED housing 20, and base unit 40 desirably include suitable connectors to enable first end 31 of neck 30 to connect with LED housing 20 and to enable second end 32 of neck 30 to connect with base unit 40. Alternatively, in an embodiment, LED housing 20 may be connected to base unit 40 without neck 30.

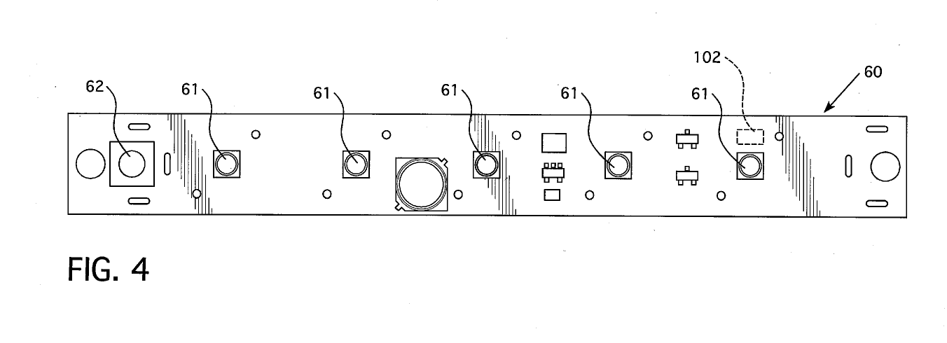

FIGS. 1 and 2A depict an embodiment of a power supply housing 50. In an embodiment, power supply housing 50 may be situated in base 40. Power supply housing 50 may be accessible through power supply housing cover 51. In an embodiment, power supply housing cover 51 may be accessible to the user through rear portion 42 of base 40. In an embodiment shown in FIG. 1, at least one battery 52 may serve as a power supply for the lighting assembly 10, and may provide power to at least one LED 61, as shown in FIG. 4.

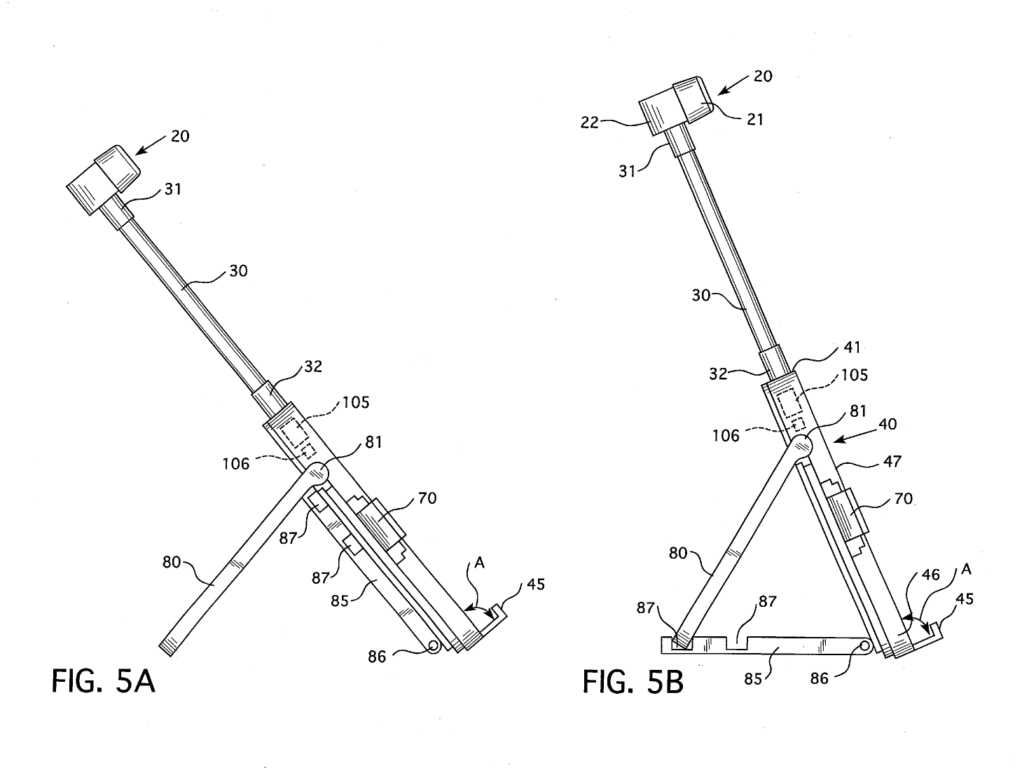

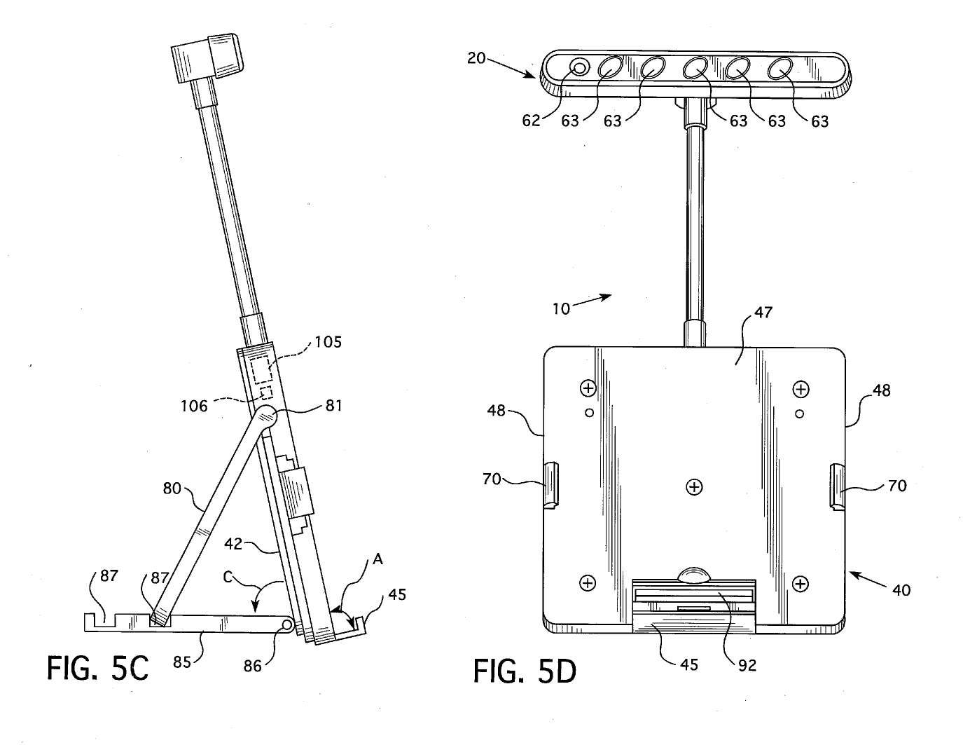

In an embodiment depicted in FIGS. 2B and 5A-5D, at least one leg member 80 may be used to support assembly 10. With reference to FIG. 2B, at least one leg member 80 may be disposed on rear portion 42 of base unit 40 in a manner that allows leg member 80 to rotatably deploy from at least one pivot point 81, wherein one end of leg member 80 remains rotatably connected to base unit 40 by means of pins or other pivoting mechanism, not shown.

Further referencing FIGS. 1 and 2A-2B, an embodiment of leg member 80 may include at least one substantially vertical member 83. Vertical members 83 may be connected by a substantially horizontal cross member 84. Each vertical member 83 connects to base unit 40 at a pivot point 81. In an embodiment, leg member 80 may be U-shaped. Alternatively, base unit 40 may include at least one leg member 80 without cross member 84. In another embodiment, multiple cross members 84 may be used. Yet another embodiment may include a configuration of vertical members 83 and at least one cross member 84 that is not U-shaped. The at least one leg member 80 may be rotatably connected to rear portion 42 of base unit 40 at pivot points 81, and may rotate out from the base unit 40 to a set angle, or a plurality of angles.

Base unit 40 may include a ledge member 45 which, when deployed, extends outwardly from a lower area 46 of front portion 47 of base unit 40. Ledge member 45 may be retracted into a storage position by rotating it in the direction of arrow A in FIG. 5C into a recess 92 in front portion 47 of base unit 40, and may be held in place in said recess by pins, rods, friction fit, or other manners known in the art. In an embodiment, ledge member 45 may slidably deploy from inside base unit 40, and may be held in position by friction forces or a locking mechanism. Ledge member 45 may be used to provide support for a personal computing device 11, such as a tablet computer, on base unit 40 when ledge member 45 is in a deployed position.

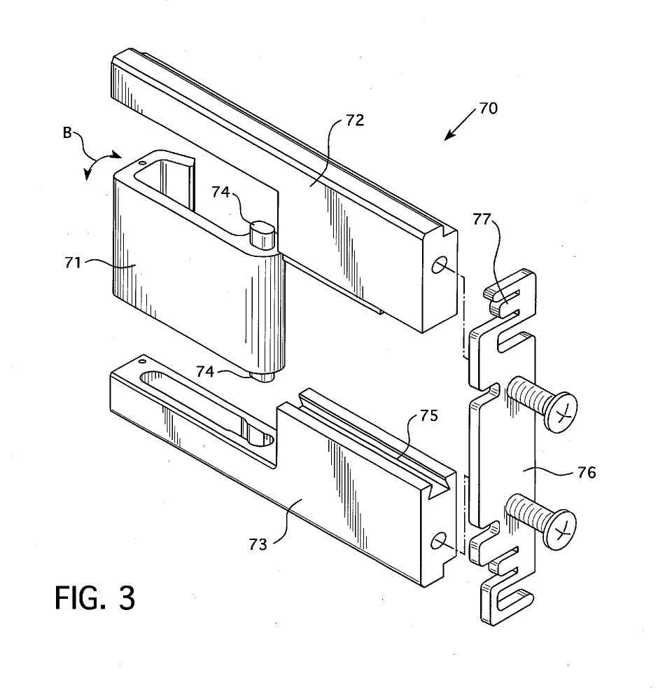

FIGS. 1 and 5D depict embodiments of lighting assembly 10 wherein a personal computing device 11 may be supported or secured on base unit 40 by means of at least one arm clip member 70, which may be included on the side portions 48 of base unit 40. As more thoroughly shown in FIG. 3, each arm clip member 70 may include a clip portion 71, an upper arm portion 72 and a lower arm portion 73, which constrain clip portion 71 and allow it to rotate in the direction shown by arrow B, so as to aid in securing a personal computing device to front portion 47 of the base unit 40. In an embodiment, clip portion 71 may have rigid or semi-rigid engaged and retracted positions.

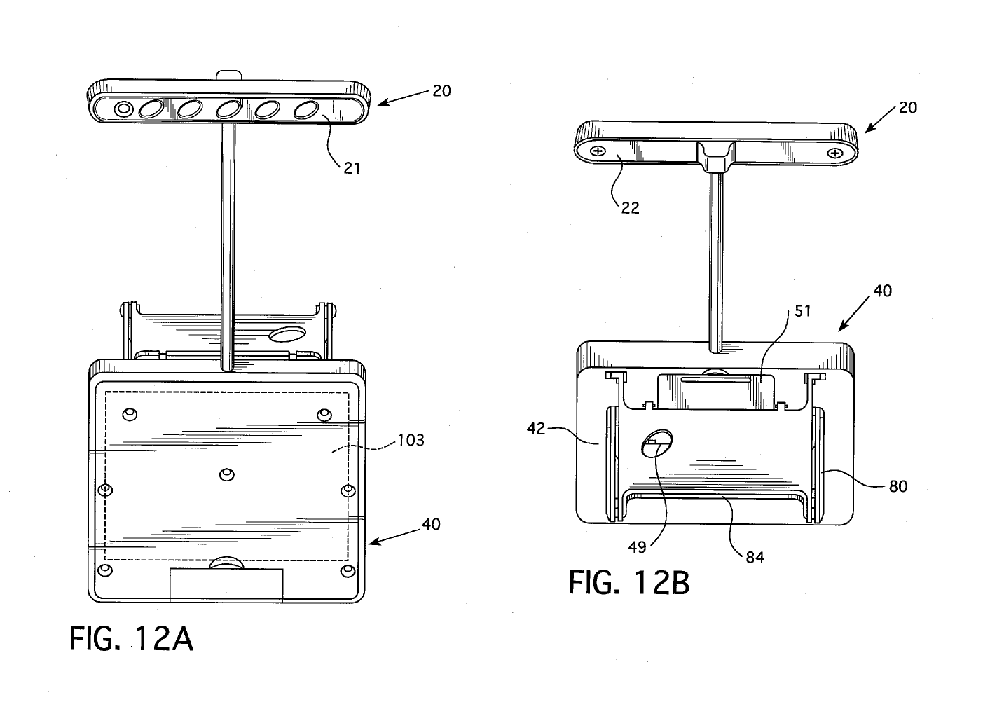

Further referencing FIG. 3, upper arm portion 72 and lower arm portion 73 may engage each other closely, for example by means of a dovetail joint 75. Mechanical fasteners, adhesives, or other means known in the art also may be used to engage upper arm portion 72 and lower arm portion 73. Upper arm portion 72 and lower arm portion 73 also may be attached to each other with a bracket 76. Bracket 76 may be comprised of galvanized steel, and may include notches 77 which engage springs, not shown, that assist in the engagement of the personal computing device by arm clip members 70. Springs may connect notches 77 to base unit 40 or to another arm clip member 70. Springs may aid in retraction of arm clip member 70 when they are not engaging a personal computing device 11, and/or to aid arm clip members 70 in supporting or securing a personal computing device 11. As depicted in FIG. 1, in an embodiment, arm clip members 70 may horizontally slidably connect to base unit 40, allowing arm clip members 70 to extend laterally, and for clip portion 71 to engage personal computing device 11 of various sizes. Line D in FIG. 1 depicts an embodiment of the path of lateral extension of arm clip member 70. In another embodiment a friction member 103, such as a foam or rubber pad, may be affixed to front portion 47 of the base unit 40, as shown in phantom lines in FIG. 12A. Friction member 103 may assist in supporting a personal computing device 11 on base unit 40 by means of friction forces, either alone or in combination with arm clip members 70 and/or ledge member 45.

As depicted in FIG. 1, an embodiment of LED housing 20 may comprise a front portion 21 and back portion 22. When engaged, front portion 21 and back portion 22 may comprise interior cavity 23, which encloses LED circuit board 60 therein. LED housing 20 may be affixed to neck 30 by means of male and female connectors. In an embodiment, male and female connectors may include a hex nut 34 disposed in port 25, and threaded male connector 35 disposed on first end 31 of neck 30. Neck 30 may include a hollow portion, not shown, through which a power wire, not shown, may be run. A power wire may run between the LED housing 20 and a power supply housing 50, and operatively connect the LED board 60 to a power supply, providing LEDs 61 with electricity. In an embodiment shown in FIG. 1, electrical current is provided from at least one battery 52 disposed in power supply housing 50. Other embodiments may include another power supply known in the art.

With reference to FIG. 1, power supply housing 50 may be disposed inside base unit 40 in an embodiment. One or more batteries 52 may be disposed within power supply housing 50, but it should be understood that various numbers or sizes of batteries 52, or a different power supply known in the art, may be used to power LEDs 61.

With reference to FIGS. 5A-5C, an embodiment of lighting assembly 10 may be powered from an external power source. In an embodiment, electrical power may be provided through an external cable, such as an electrical cable, USB cable, micro-USB cable, or other cable known in the art, which may be removably inserted into first connector port 105. First connector port 105 may be operatively connected to LED circuit board 60. Multiple connector ports—such as second connector port 106—also may be included in lighting assembly 10, so that power may be supplied through various types or standards of cables or connectors. One or more connector ports may be included in assembly 10, and may be disposed, in non-limiting embodiments, on base unit 40, or LED housing 60. In an embodiment, a USB or similar cable connected to first connector port 105 or second connector port 106 may be used to operatively connect to personal computing device 11. Power for lighting assembly 10 may be drawn from personal computing device 11, which may serve as a primary or secondary power supply for assembly 10. In an embodiment, power drawn from an external source, such as a personal computing device 11, may be used to recharge batteries 52 disposed in power supply housing 50. It should be understood that connector ports 105 and 106 also may be included in embodiments without base unit 40, such as those depicted in FIGS. 9A and 9B.

With reference to FIG. 1, base unit 40 additionally is shown to house two arm clip members 70, as described above. Front portion 47 and rear 42 portion of base unit 40 may be attached using mechanical fasteners, adhesive, a combination of the two, or by another manner known in the art.

Lighting assembly 10 may include at least one LED 61. FIG. 4 depicts an embodiment of an LED circuit board 60 on which is disposed a plurality of LEDs 61. Five LEDs 61 are shown on LED circuit board 60 depicted in FIG. 4, but it should be understood that more or fewer could be included in other embodiments. In an embodiment, LEDs 61 may be configured to emit light within the warm range on the Kelvin scale, or between 2000K-3500K. In another embodiment, LEDs 61 may be emit light at approximately 3200K. In another embodiment, LEDs 61 may emit light in the cool range of the Kelvin scale, or between 5100K-10000K. In another embodiment, LEDs 61 may emit light at approximately 5600K on the Kelvin scale. Additionally, LEDs 61 may have a +82 color rendering index.

Lighting assembly 10 also may include an input device 62. With further reference to FIG. 4, input device 62 may be disposed on LED circuit board 60, and may be accessible to a user through front portion 21 of LED housing 20. Input device 62 may control the output of power to the LEDs 61, and may comprise a switch.

Input device 62 may be used to control a plurality of outputs of light from LEDs 61. Multiple intensities of light output may help assembly 10 provide proper lighting to users with various skin tones, or in various levels of background light. In an embodiment, a plurality of outputs may be accomplished simply by turning on or off individual LEDs 61 on the LED circuit board 60. A user may choose to turn on various LEDs 61 or groups of LEDs 61 by making multiple depressions of input device 62. In a non-limiting embodiment, pressing input device 62 once may result in half of the LEDs 61 on board 60 being turned on. A second depression of input device 62 may result in the remaining LEDs 61 being turned on. Depressing input device 62 a third time may result in all LEDs 61 turning off. This may be accomplished by the use of switches, or other manners known in the art. LED circuit board 60 may include logic and a controller to control light output. In an embodiment, the output, brightness, or intensity of light emitted from LEDs 61 may be varied by using at least one resistor 102, which may be included on an embodiment of the LED circuit board 60, as shown in phantom lines on FIG. 4. In an embodiment, resistor 102 is a variable resistor.

With further reference to FIGS. 5A-5C, in an embodiment, software on personal computing device 11 may be used to control LEDs 61 through a USB or other cables operatively connected to personal computing device 11 and lighting assembly 10 at first connector port 105 or second connector port 106.

With further reference to FIG. 4, an embodiment of LED circuit board 60 and LEDs 61 do not include adjustable pulse width modulation circuitry. In another embodiment, input device 62 turns on and off LEDs 61 without varying light output. In other embodiments, input device 62 may be disposed on base unit 40, neck 30, or power supply housing 50, as depicted phantom lines in FIG. 9B.

Direct light from LEDs may cause eye strain or discomfort to users. Discomfort may be exacerbated if a user is positioned only a few feet from the LEDs 61 when they are emitting light. In an embodiment, assembly 10 is configured to illuminate a user in a manner that minimizes bright spots and light bands, and may decrease user discomfort and eye strain as well. FIG. 10B, depicts a cross section of an embodiment of LED housing 60 shown in FIG. 10A. In the non-limiting embodiment depicted in FIG. 10B, optics 63 may be positioned in front portion 21 of LED housing 20, between a user and LEDs 61, so that light emitted by LEDs 61 passes through optics 63 prior to reaching a user. An embodiment of optics 63 depicted in FIG. 10B includes a clearance space 69 in which LED 61 may be seated. Optics 63 may include support structure 67, which may position optics 63 over LED 61 in a desired configuration, or such that LED-side optical surface 65 is a desired distance from LED 61. Support structure 67 may be attached to LED board 60 by means of adhesives, or in another manner known in the art. In an embodiment at least one substantially transparent or translucent cover portion 68 may be placed holes 64 in front portion 21 of LED housing 20 between optics 63 and a user. Cover portion 68 may protect optics 63 from scratching or other damage. In an embodiment, cover portion 68 may help to shape the light emitted by LEDs 61, as further described below.

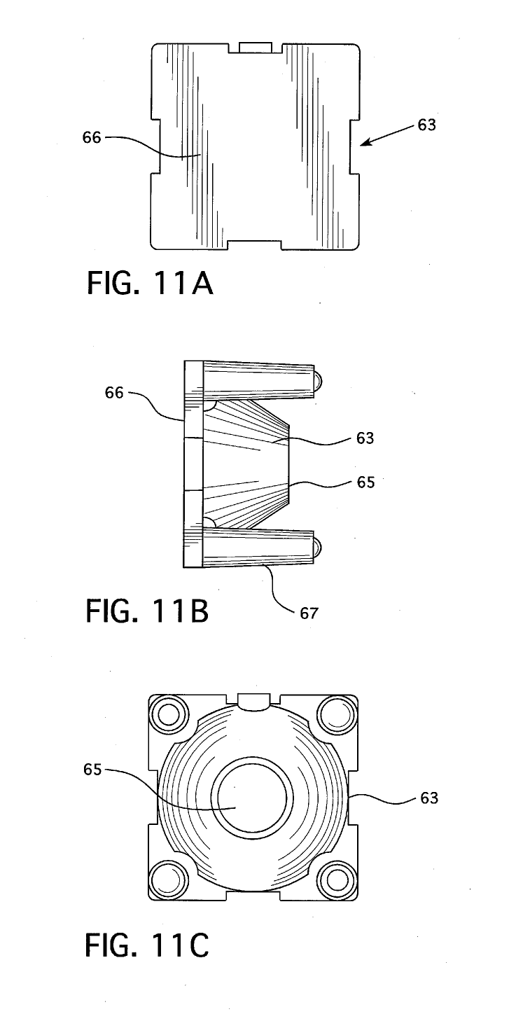

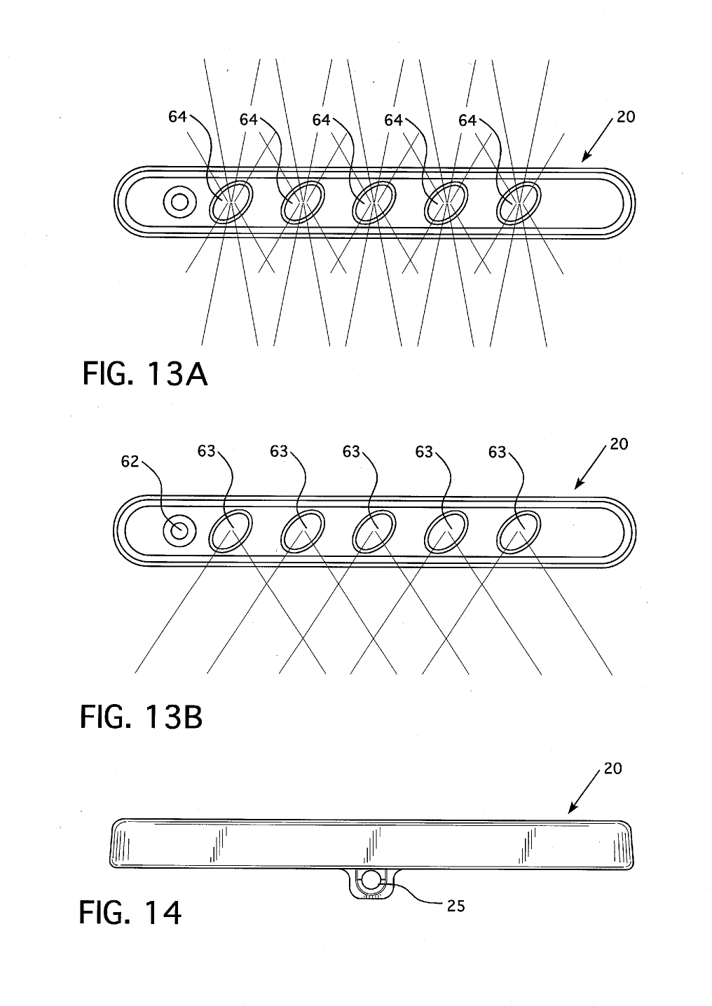

An embodiment of optics 63 is depicted in FIGS. 11A-11C. Optics 63 may shape the light emitted by LEDs 61. Light emitted by LED 61 enters optic 63 at an LED-side 65, travels through optics 63, and exits optics at observer-side surface 66. In an embodiment, optics 63 shape or narrow the rays of light emitted by LEDs 61, so that the beams converge on a user. FIG. 13A depicts an example of a LED housing 20, in which light is emitted by LEDs 61 through holes 64 in front portion 21 of LED housing 20, and wherein optics 63 are not included. FIG. 13B shows the shaping of light rays in an embodiment of the present invention wherein an embodiment of optics 63 is included between LEDs 61 and a user. Optics 63 may provide continuous light coverage over a user, while minimizing bright points or “hot spots” on the user. Optics 63 also may reduce bands of bright areas, which may occur in other configurations, such as when light emitted by LEDs 61 do not pass through optics 63, as described above. Thus, embodiments of assembly 10 which include optics 63 may provide high-quality illumination, and may decrease eye strain and user discomfort, during video conferencing. The beam shape may be optimized by adjusting the distance of optics 63 from LEDs 61 during fabrication of assembly 10. In an embodiment observer side surface 66 of optics 63 is positioned about six millimeters from LEDs 61. In an embodiment seen in FIG. 10B, optics 63 may possess a clearance space 69 configured to receive an LED 61, so that the optical medium surrounds the surface of LED 61 from which light is emitted. Optics 63 may be substantially clear, and may include a frosted finish. In a further embodiment, optics 63 are not colored diffuser lenses. Optics 63 may be comprised of polycarbonate, or other material in the art known to possess the optical qualities necessary for shaping light emitted by LEDs 61. Optical surfaces of optics 63 may possess an optical polish. Embodiments of optics 63 may include total internal reflection (“TIR”) lenses. An embodiment of optics 63 may comprise multiple media with different optical properties, such as different indices of refraction.

With reference to FIGS. 11B-11C, embodiments of optics 63 may include a support structure 67 to aid in proper placement over LEDs 61. A non-limiting example of optics 63 is the Carclo® model 10413 10 mm square medium frosted optic, available from Carclo Optics in Latrobe, Pa. However, it should be understood that other optics known in the art to shape beams of light to provide continuous light coverage on a user, while minimizing bright points or “hot spots” on the user, may be used as well.

In another embodiment, a user's ability to adjust the orientation of LED housing 20, and to control the intensity of light emitted from LEDs 61, further may contribute to user comfort and quality of illumination for video conferencing.

FIGS. 5A-5C are side views of an embodiment of assembly 10 including a leg support member 85 which may be rotatably connected to base unit 40 with pins, rods, or in some other manner, to allow it to rotate out from a pivot point 86 at one end of leg support member 85. Leg support member 85 may connect to the base unit 40 at one or more pivot points 86. Leg support member 85 further may rotate in the direction shown by arrow C in FIG. 5C so that, when deployed, leg support member 85 may engage leg member 80 to allow assembly 10 to support a personal computing device on base unit 40 at various, set angles. In an embodiment, leg support member 85 may include at least one notch 87 in which leg member 80 may be disposed when leg member 80 also is in a deployed position. An embodiment of the leg support member 85 depicted in FIGS. 5A-5C includes two sets of notches 87, but it should be understood that more, or fewer notches, may be included in various embodiments of the present invention.

In another embodiment, leg member 80 requires no leg support member 85. As seen in an embodiment depicted in FIG. 2A leg member 80 may retract rotatably into a complementary-shaped recessed area 49 in rear portion 42 of base unit 40. FIGS. 12A-12B disclose another embodiment wherein leg member 80 may deploy from rear portion 42 of base unit 40. In an embodiment, angle of deployment of leg member 80 may be set by friction fit, ratcheting system, or another manner known in the art.

FIGS. 6A and 6B show another embodiment of assembly 10. Power supply housing 50 is not shown in FIG. 6B for clarity. In this embodiment, back portion 22 of the LED housing 20 is connected via pivot 26 to the neck 30. Other embodiments may allow LED housing 20 to be rotatably connected to neck 30 as well. An embodiment of neck 30 in FIG. 6B is depicted as being rigid and adjustable in height with a thumb screw 36. However, it should be understood that neck 30 also could be flexible as earlier described, an embodiment of which is depicted in FIG. 8. Neck 30 attaches to a clipping mechanism 95 that engages a personal computing device. Clipping mechanism 95 may include a front portion, 37, a back portion 38, and a spring 39 which biases front portion 37 and back portion 38 about a pivot 91. In an embodiment, front 37 and back 38 portions of clipping mechanism 95 may be separated about pivot 91 to engage the front and back of the personal computing device display, whereupon spring 39 biases front 37 and back 38 of clipping mechanism 95 into contact with front and back portions of a personal computing device 11. Clipping mechanism 95 may be configured not to obscure a camera 104 integrated in the personal computing device 11, such as a tablet computer. Power supply housing 50 may be incorporated in this embodiment substantially as described below.

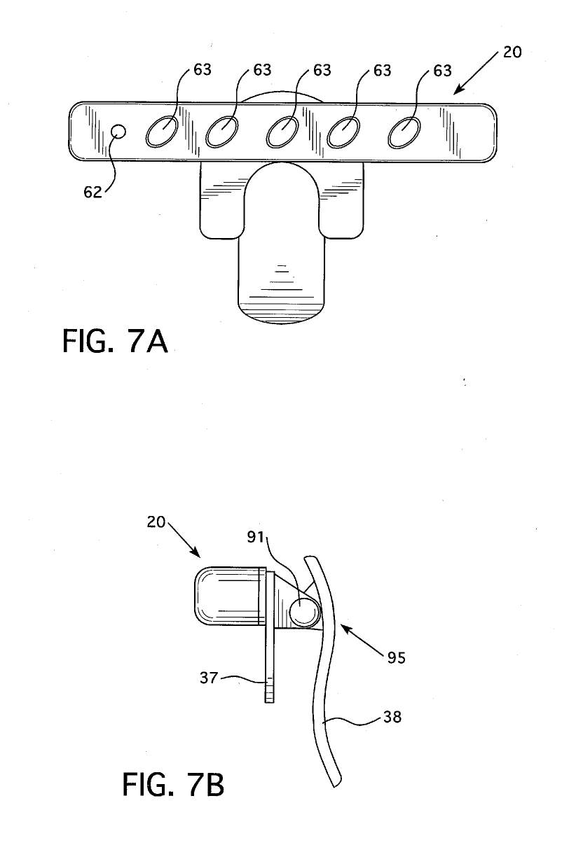

FIGS. 7A and 7B depict an embodiment of lighting assembly 10 wherein LED housing 20 includes a clipping mechanism 95 without neck 30. FIGS. 7A and 7B do not show power supply housing 50 for clarity. Front portion 37 of clipping mechanism 95 is configured not to obscure a camera 104 integrated into personal computing device 11. Back portion 38 of clipping mechanism 95 may attach to back portion 22 of the LED housing 20 with a steel rivet, adhesive, pivot, or another manner known in the art. Power supply housing 50 may be incorporated in this embodiment substantially as described below.

In an embodiment depicted in FIGS. 9A-9B, power supply housing 50 is attached to back portion 38 of clipping mechanism 95. Power supply housing 50 may be configured to receive at least one battery 52, or other power supply known in the art, in order to provide electrical current to LED board 60 and LEDs 61. Power supply housing 50 may be positioned on, or comprise, back portion 38 of clipping mechanism 95, below LED housing 20 and neck 30. When clipping mechanism 95 is engaged on the personal computing device, power supply housing 50 may be positioned behind the back portion of the display of the personal computing device 11, so that power supply housing 50 does not obscure the camera or display thereof.

Although assembly 10 has been described in detail by illustrative embodiments, it is to be understood that such detail is solely for that purpose and that the invention is not limited to the disclosed embodiments, but, on the contrary, is intended to cover modifications and equivalent arrangements. For example, it is to be understood that the present invention contemplates that, to the extent possible, one or more features of any embodiment can be combined with one or more features of any other embodiment.

It is to be understood that the invention may assume various alternative variations, except where expressly specified to the contrary. It is also to be understood that the specific devices illustrated in the attached drawings, and described in the specification, are simply exemplary embodiments of the invention. Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope thereof. For example, it is to be understood that the present invention contemplates that, to the extent possible, one or more features of any embodiment can be combined with one or more features of any other embodiment.

The invention claimed is:

1. A lighting assembly for use in personal video conferencing comprising:
an LED housing, comprising a front portion and a back portion, and defining a first interior cavity;
an LED circuit board comprising at least one LED, wherein the LED circuit board is enclosed within the first interior cavity and wherein the front portion of the LED housing includes at least one opening;
wherein the at least one LED is situated to emit light toward a user through the at least one opening;
a power supply, wherein the power supply is operatively connected to the LED circuit board;
an input device configured to control a flow of an electric current from the power supply to the at least one LED; and
at least one optic disposed between a user and the least one LED, wherein the at least one optic is substantially transparent in a visible spectrum of light, and wherein the at least one optic shapes the light emitted by the at least one LED.

2. The lighting assembly of claim 1 further comprising:
a neck comprising a first end and a second end,
wherein the LED housing is attached to the first end of the neck; and
a power supply housing comprising a second interior cavity configured to house the power supply.

3. The lighting assembly of claim 2, further comprising:
a clipping mechanism comprising a front portion, a back portion,
wherein the clipping mechanism is affixed to the second end of the neck; and
wherein the front portion and the back portion are configured to removably attach to a personal computing device.

4. The lighting assembly of claim 3, wherein the front portion of the clipping mechanism is configured to avoid a camera that is integral to the personal computing device.

5. The lighting assembly of claim 4, wherein the back portion of the clipping mechanism comprises the power supply housing.

6. The lighting assembly of claim 2, wherein the neck is a flexible neck.

7. The lighting assembly of claim 6, further comprising:
a base unit connected to the second end of the flexible neck, the base unit comprising:
a front portion, a rear portion, and at least one leg member
wherein the at least one leg member is rotatably connected to the base unit;
wherein the at least one leg member has a retracted position and at least one deployed position; and
wherein the at least one leg member is configured to support the lighting assembly in at least one titled position corresponding to the at least one deployed position;
and wherein the front portion of the base unit is configured to support the personal computing device in the at least one deployed position.

8. The lighting assembly of claim 7, wherein a friction pad is affixed to the front portion of the base unit.

9. The lighting assembly of claim 7, further comprising:
at least one arm clip member, comprising a clip portion,
wherein the arm clip member is slidably connected to the base portion; and
wherein the clip portion is configured to engage the personal computing device.

10. The lighting assembly of claim 9, wherein the at least one arm clip member is attached to the base unit with at least one spring.

11. The lighting assembly of claim 7, further comprising:
a ledge member connected to the base unit,
wherein the ledge member has a deployed position and a retracted position; and
wherein the ledge member is configured to support the personal computing device on the front portion of the base unit when the ledge member is in the deployed position.

12. The lighting assembly of claim 1, wherein the at least one LED emits light that is between 2000K-3500K on a Kelvin scale.

13. The lighting assembly of claim 12, wherein the at least one LED emits light that is approximately 3200K on the Kelvin scale.

14. The lighting assembly of claim 1, wherein the at least one LED emits light that is between 5100K-10000K on a Kelvin scale.

15. The lighting assembly of claim 14, wherein the at least one LED emits light that is approximately 5600K on the Kelvin scale.

16. The lighting assembly of claim 1, wherein the at least one LED has a +82 color rendering index.

17. The lighting assembly of claim 1, wherein the power input device is accessible to the user through the front portion of the LED housing.

18. The lighting assembly of claim 1, wherein the at least one optic is a total internal reflection lens.

19. The lighting assembly of claim 1, wherein the input device controls an output of light emitted by the at least one LED based on actuation by the user.

20. The lighting assembly of claim 7, wherein the power supply housing is contained in the base unit.
